(19) United States
(12) Patent Application Publication
(10) Pub. No.: US 2003/0056218 A1
(43) Pub. Date: Mar. 20, 2003

(54) System and method to provide content and corresponding applications via carousel transmission to thin-client interactive television terminals

(75) Inventors: Steven C. Wingard, Auburn, WA (US); Quang P. Tang, Bothell, WA (US); Randall J. Carlson, Sammamish, WA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: Digeo, Inc., Kirkland, WA

(21) Appl. No.: 10/213,942

(22) Filed: Aug. 6, 2002

Related U.S. Application Data
(60) Provisional application No. 60/310,851, filed on Aug. 6, 2001.

(51) Int. Cl. H04N 7/16; H04H 9/00; H04N 7/025; H04N 7/10; G06F 3/00; H04N 5/445; G06F 13/00

(52) U.S. Cl. 725/46; 725/9; 725/34

(57) ABSTRACT

Content and corresponding applications can be provided to thin-client interactive television terminals. Localization may be performed on general data feeds by applying, at a portal that receives the data feeds, localization parameters specified in a plurality of channel configuration records. The content is then provided to their corresponding head-ends. From the head-ends, the content and its application are carousel broadcasted to thin-client terminals via different data pipes. A viewer can tune to a synthetic channel having the content and application via familiar television metaphors, such as from a remote control or from an electronic program guide. The viewer's interaction with the content can be limited to a walled garden.

### CROSS REFERENCE TO RELATED APPLICATION

This application claims the benefit of U.S. Provisional Patent Application Serial No. 60/310,851, entitled “THIN-CLIENT ITV SYSTEM,” filed Aug. 6, 2001, assigned to the same assignee as the present application, which is incorporated herein by reference in its entirety.

### BACKGROUND OF THE INVENTION

1. Field of the Invention

This disclosure relates generally to transmission and presentation of information on a display device, and in particular but not exclusively, relates to providing content to thin-client interactive television terminals.

2. Description of the Related Art

Interactive television is expected to increase in use and popularity in the coming years. Unlike conventional broadcast television, interactive television allows viewers to access a wide range of interactive content that is unavailable via conventional television sets. For instance, viewers can order advertised products while viewing a commercial, access and view supplemental content “on-demand” while viewing a television program, and access various interactive channels.

For most interactive television systems, a set top box (STB) is often used as the client terminal to receive, decode, and otherwise process received content for presentation on the television set. As interactive television systems become more developed, “thick-client” STBs will become the predominant type of client terminal to process interactive content. These STBs get their “thick-client” nickname from the fact that they can store and process a large amount of applications and content, in a manner similar to an advanced computer. This sufficient processing and storage capability allows such STBs to be installed or downloaded with potentially hundreds of different types of interactive applications and content, and to execute such applications in an enhanced and substantially latency-free manner.

Unfortunately, most STBs currently are and will continue to be (for the time-being) “thin-client” terminals. The “thin-client” nickname derives from the fact that such STBs have significantly less processing and storage capability than their thick-client counterparts. Thus, in order to be usable for interactive television systems, interactive applications (and content) for thin-client STBs are executed one at a time (or one “piece” of code at a time), and then rapidly cleared from memory so that the next application (or piece of code) can be executed. The applications themselves are not typically installed in their entirety in a thin-client STB, since there is insufficient storage capacity. Rather, applications are sent piece by piece via carousel transmission from a head-end to the thin client terminal, such as disclosed in U.S. Pat. No. 5,819,034 to Joseph or provided by Wink™ Communications of Alameda, Calif.

As a practical matter, most households will continue to use thin-client STBs for at least several more years. Efficient and user-friendly thick-client STBs are still being developed, and are not yet affordable to many consumers. This is an unfortunate situation for consumers because they will not be able to take advantage of the rich offerings provided by interactive televisions—their thin-client STBs simply do not have the capacity to provide them with interactive access in a manner similar to thick-client STBs.

As an example, local content (such as local weather, local sports, etc.) is often difficult to provide through thin-client STBs. Rather, thin-client STBs generally receive the same “universal” content (e.g., non-localized content) that is available to other STBs, and it is up to the viewer to locate local content (if any) from the universal content received by the STB. Thus, in order to view local weather information, the viewer typically has to scan national or regional weather listings obtained by the STB when these general listings are displayed by the television. In contrast, thick-client STBs may have sufficient filtering or processing software to request, identify, extract, and present local content (from the large quantity of universal content that they receive) at a much finer granularity than that of a thin-client STB.

Moreover, interactive local content is generally clumsy to access with thin-client (or thick-client) STBs. The viewer typically has to navigate through various menus, sub-menus, or settings pages to select interactive local content for viewing. If the viewer is unfamiliar with the particular user interface, the viewer may end up lost in the directory of menus and accidentally access sports news (or be taken to some other completely irrelevant interactive area) when intending to find some type of local weather report.

As another issue, carousel systems often broadcast application and data in the same data pipe, or broadcast the application in a first data pipe while placing all the data in a carousel broadcast in a second data pipe. This creates latency problems at the client terminal because the client terminal has to “wait” for particular pieces of data to arrive in the carousel broadcast, so that it can “pick them off” in their turn, while other data passes by in the carousel broadcast and is not picked off. Thus, if a single packet of data in a long carousel of packets is the only item of interest, a non-optimum situation exists since all the other packets need to finish carouseling before the item of interest can be picked off.

### BRIEF DESCRIPTION OF THE SEVERAL VIEWS OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an example interactive video casting system that can provide content and applications to thin-client terminals in accordance with an embodiment of the invention.

FIG. 2A is a block diagram showing in more detail some of the components of the system of FIG. 1, which are used to provide content and applications to thin-client terminals in accordance with an embodiment of the invention.

FIG. 2B is a block diagram showing another embodiment to provide content and applications to thin-client terminals.

FIG. 2C illustrates carousel transmission of content and applications in different data pipes according to an embodiment of the invention.

FIG. 2D illustrates an embodiment to map synthetic channels having content and applications into an electronic program guide having conventional television channel listings.

FIG. 3 is a block diagram of an embodiment of a thin-client terminal that can be used in the system of FIGS. 1 to present content.

FIG. 4 is an example screen shot in conjunction with a remote control for implementing one embodiment of the invention to allow a viewer to tune to content.

FIGS. 5-6 are screen shots depicting presentation of content in accordance with various embodiments of the invention.

FIG. 7 is a flowchart illustrating operations associated with providing content for carousel transmission according to an embodiment of the invention.

FIG. 8 is a flowchart illustrating thin-client terminal operations associated with obtaining and presenting content according to an embodiment of the invention.

### DETAILED DESCRIPTION

Embodiments of techniques to provide content and corresponding applications to thin-client terminals are described herein. In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, one embodiment of the invention provides content, such as local content, and corresponding applications to thin-client terminals of an interactive television system. In one implementation, localization may be performed at a portal where all content is initially received from content providers, at head-ends, or in suitable intermediate locations.

Various techniques may be used to localize the content prior to transmission to client terminals. Examples include, filtering based on zip codes, geographic radius look-up, time zones, adding destination tags or other usable indicia to the content, demographic data, using applications at the portal to identify and select local content for the geographic location specific to the head-ends, and other techniques. In one embodiment, a channel configuration record may be used by a server module to identify local content received from sources and to determine where to send that local content.

An application corresponding to the content (such as a weather application, in this example) is carousel-broadcast from the head-end to the thin-client terminals. According to one embodiment, the weather application may be constantly carousel-broadcast and then “picked off” the carousel broadcast when the thin-client terminal needs the application, such as when a viewer tunes to a weather channel. The application may be carousel broadcast via one or more data pipes. Similarly, the corresponding content (such as the local weather information) may be carousel broadcast via one or more data pipes, and then picked off by the thin-client terminal. In this manner, thin-client terminals are specifically provided with highly localized content—subtly different applications are present in the different head-ends to allow them to identify and send subtly different content to their respective thin-client terminals.

Optimization techniques can be used to improve the efficiency of the carousel transmission. In an embodiment, the manner that the applications and content are arranged and placed on the data pipes may be based on predicted viewer behavior. As an example, an entertainment channel can be provided to allow a viewer to view movie listings, theater locations, and show times. A typical viewer first tunes to the channel, then scans the movie listings and accompanying movie descriptions, and then lastly looks at theater locations and show times. Thus, based on this predicted viewer behavior, the entertainment application is placed in a first data pipe (and later rendered as a “template” to be filled in with content), along with perhaps content that needs to be rendered quickly once the application is launched to render the template, such as a banner graphic for “The Entertainment,Channel.” In another data pipe, movie listings and moving descriptions are carouseled. In yet another data pipe, theater locations and show times are carouseled. By separating transmission of these types of information in different data pipes, the STB can readily tune from one data pipe to another to obtain the needed information quickly, rather than tuning to a lesser number of pipes (having a larger number of content carouseled therein) and having to “wait” for the needed information to carousel its way through after the others.

In one embodiment, the viewer can tune to the content in a manner similar to conventional television viewing metaphors. For instance, the content can be presented in “synthetic channels” or other interactive content channel configured by the interactive service provider. Each of these synthetic channels has a channel number associated with it—the viewer can tune to a synthetic channel by pressing its channel number on a remote control, or by using channel up/down arrow buttons on the remote control. Alternatively or in addition, the synthetic channels can be tunable via an electronic program guide (EPG), which displays the synthetic channel selections along with other broadcast television channel selections. Thus, a familiar and easy-to-use interface is provided for viewers to locate and tune to interactive channels.

According to an embodiment, the tunable content can be configured as part of a “walled garden.” With this walled garden, the interactive service provider can control which interactive areas that particular viewer segments can access. For instance, a walled garden may be configured to allow the viewer to access only weather, sports, news, advertisements, and on-line merchant sites corresponding to the content—special permissions/restrictions may be placed into effect to keep viewers from accidentally or intentionally accessing interactive areas outside of their walled garden, including content from geographically distant areas. Thus, even if a viewer wishing to view content is unfamiliar with the simple user interface and accidentally presses the wrong channel navigation buttons, the walled garden keeps the viewer within an interactive area that may be of interest, and prevents the viewer from navigating into and getting lost in completely irrelevant interactive areas.

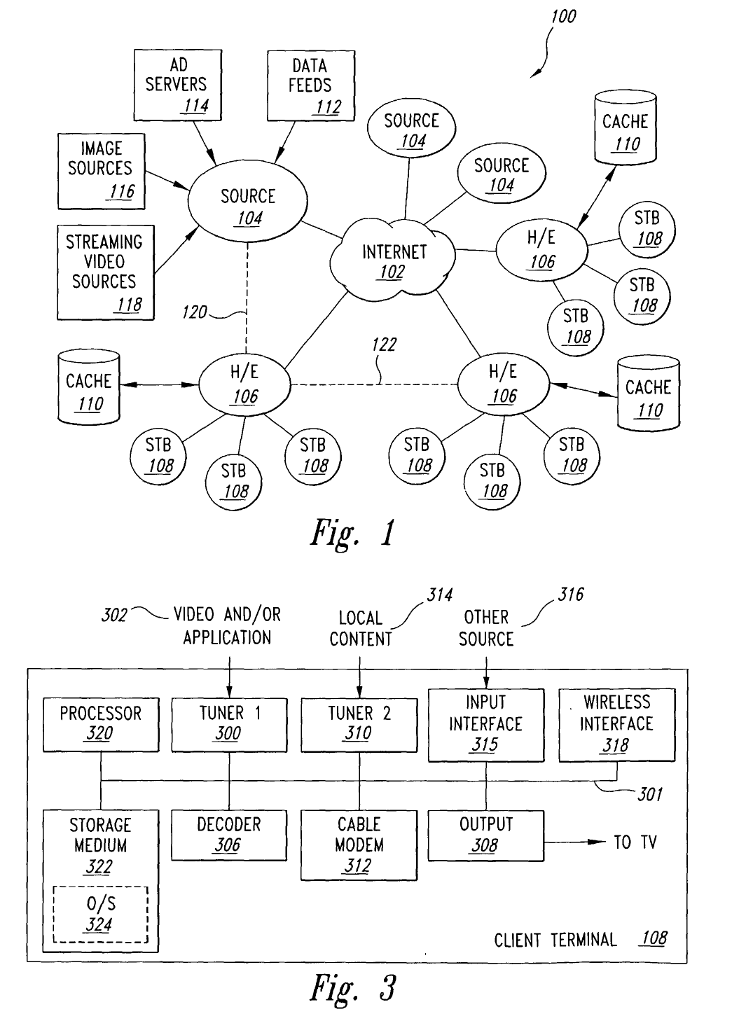

FIG. 1 shows an example of an interactive video casting system 100 for distributing interactive content (including television content) according to an embodiment of the invention. In accordance with an embodiment of the present invention, the system 100 can be integrated with a cable television distribution system to provide an interactive television system. The system 100 includes an Internet 102, a plurality of content sources 104, a plurality of distribution centers (depicted as the head-ends or H/Es 106), and a plurality of client terminals 108 (depicted as set top boxes). In addition, a content source 104 is depicted as receiving data from data feeds 112, advertisement servers 114, image sources 116, and streaming video sources 118. The content source 104 may also receive content from a broadcast video source. For the sake of clarity and to avoid clutter, not all of these sources are shown in FIG. 1 for each content source 104.

The plurality of content sources 104 is coupled to the Internet 102. For example, a content source 104 may comprise a web site portal such as Go2Net.com™, or a news web site such as CNN.com™, or other types of sources. Each content source 104 may have various data feeds 112, servers 114, and sources 116/118 coupled to it.

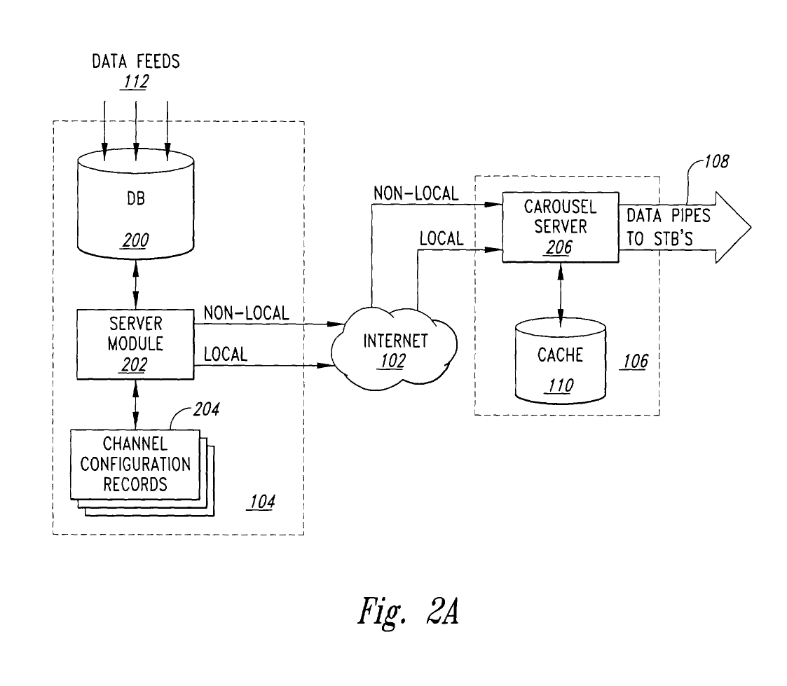

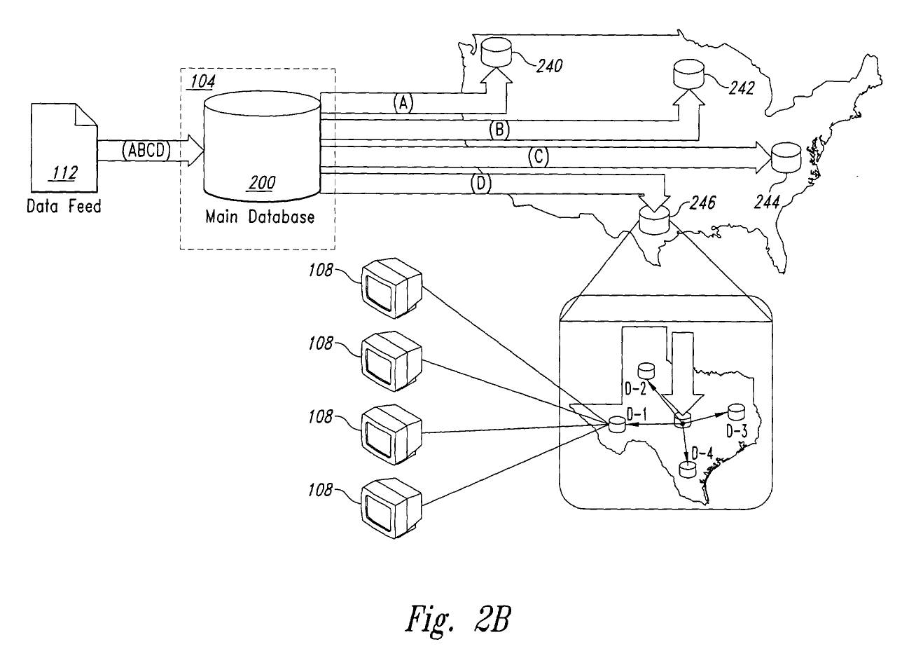

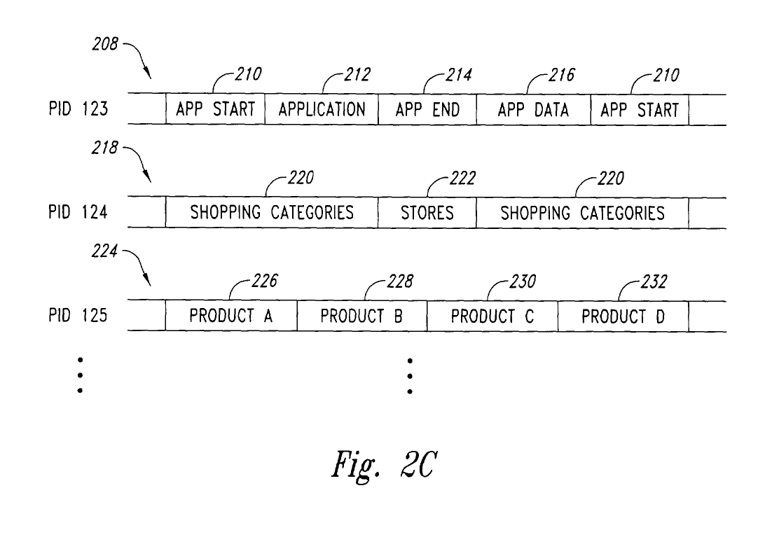

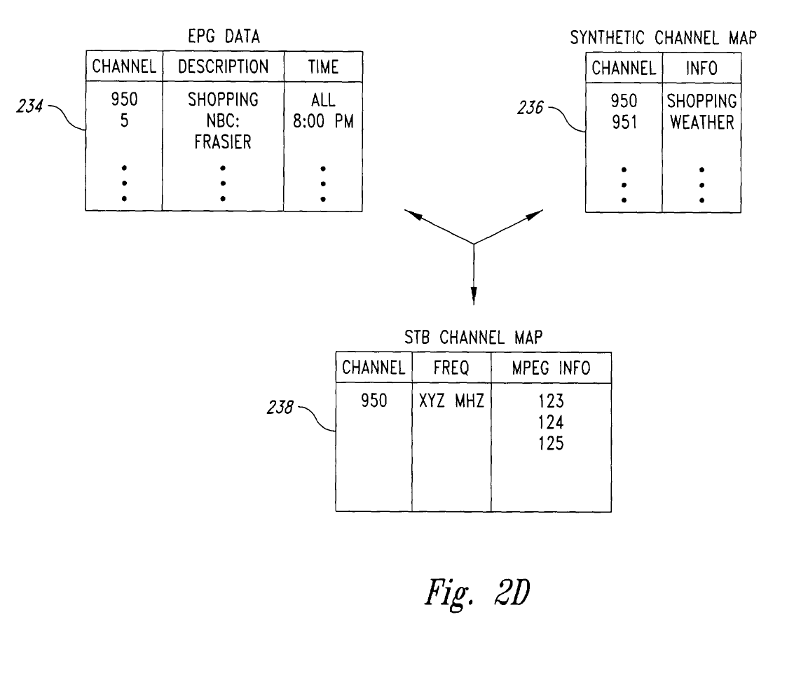

For example, news or stock quote feeds 112 (including content to be localized) may be fed into the content source 104. Servers 114 may provide advertisements for insertion into multimedia content delivered by the content source 104 in accordance with one embodiment of the invention. Sources 116 and 118 may provide images 116, streaming video 118, and other content to the content source 104. Various other feeds, servers, and sources may also be coupled to the content source 104 of FIG. 1. An example configuration of components that can be integrated with the system 100 for purposes of content localization is shown in FIGS. 2A-2B.

The Internet 102 comprises a network of networks and is well known in the art. Communications over the Internet 102 can be accomplished using standard protocols such as transmission control protocol/internet protocol (TCP/IP), hypertext transfer protocol (HTTP), file transfer protocol (FTP), or other protocols. Web sites, such as merchant web sites, can be included within or otherwise be in communication with the Internet 102. The Internet 102 is coupled to the plurality of distribution centers 106, and each distribution center 106 is in turn coupled to a plurality of client terminals 108, which may comprise a thin-client set top box or other thin-client terminal according to an embodiment of the invention.

In alternative or in addition to the Internet 102 being used to distribute multimedia content from the content sources 104 to distribution centers 106, communications channels or networks 120 (which can include satellite delivery sources/networks) apart from the Internet 102 may couple one or more content sources 104 to one or more distribution centers 106. One example of such an alternate path for communications is illustrated by a first dashed line 120 in FIG. 1. Alternately or additionally, peering connections may exist between distribution centers 106. One example of such peering is illustrated by a second dashed line 122 in FIG. 1. Other communications configurations are also possible and are included within the scope of the present invention.

Caches 110 may be provided at (or otherwise coupled to) the distribution centers 106. Such caches 110 may be used to increase the performance in the delivery of multimedia content to the client terminals 108. For example, larger files for video and other high bandwidth content may be stored in such caches 110, which may be closer-in-time to the client terminals 108 than to the content sources 104. In addition, reliability and guaranteed bandwidth may be provided because the Internet 102 is not in-between such caches 110 and the client terminals 108. In one embodiment, the caches 110 or other storage media in the system 100 can store content and applications for carousel transmission to the client terminals 108.

In an embodiment, servers may be present in the distribution centers 106, with such servers including or being coupled to the caches 110 or other storage media. Alternatively or in addition, these servers may be located remotely from but still communicatively coupled to the distribution centers 106, via the Internet 102 or other communications channels or networks. Examples of such servers that can be used in connection with providing content and applications to client terminals 108 via carousel transmission are shown in FIG. 2A.

FIG. 2A is a block diagram showing in more detail some of the components of the system 100 of FIG. 1, which are used to provide content and applications to thin-client terminals 108 in accordance with an embodiment of the invention. The content source 104 or “portal” includes a database 200 or other storage unit. The database 200 is configured to receive and store data received from the data feeds 112 and/or from other data sources 114-118 depicted in FIG. 1. Examples of the data feeds 112 include The Sporting News (TSN™) for sports content, AccuWeather for weather content, Reuters, and other plurality of content that can be transferred to the database 200 en masse.

In one embodiment, the incoming data from the data feeds 112 can arrive according to a pre-defined schema configured by the content provider and/or configured for the database structure and format of the database 200. For instance for weather data, the weather schema can include: city, 5-day forecast, current conditions, high/low temperatures, record temperatures, and so forth. Each of these pieces of incoming data can be tagged with identifiers to identify what kind of data it is and where (e.g., which distribution center 106) it is destined to go. Various data-tagging techniques familiar to those skilled in the art having the benefit of this disclosure can be used to tag the incoming data. Additional example techniques to tag the incoming data (via routing identifiers) that can be used by one embodiment of the invention are disclosed in U.S. application Ser. No. ______[Digeo Docket No. 677], entitled “METHOD AND SYSTEM TO PROVIDE LOCAL INFORMATION VIA A CHANNEL OF AN INTERACTIVE VIDEO CASTING NETWORK,” filed Jun. 28, 2002, with inventors Aaron J. Sheedy, Charles A. Delaney, Steven C. Wingard, Quang P. Tang, and P.G. Scott Born, and assigned to the same assignee as the present application.

The content source 104 further includes a plurality of channel configuration records 204. In an embodiment, the channel configuration records 204 comprise files (that can be changed or updated) corresponding to each synthetic channel provided by each head-end 106. For example, there may be separate configuration records 204 for the Shopping Channel for the Bellevue, Wash. head-end and for the Shopping Channel for the Austin, Tex. head-end. In other embodiments, configuration records 204 corresponding each channel can include multiple cities in the same record. One example implementation uses XML files as the configuration records 204, rather than or in addition to database tables.

Each configuration record 204 is made up of two sections. A first section details which content is to be common to all geographic locations. An example is “national news” that is to be provided on all synthetic news channels, irrespective of the geographic location of the corresponding head-end. A second section of the configuration record 204 provides unique localization parameters for each head-end. For example, a configuration record 204 corresponding to the Shopping Channel in the Bellevue, Wash. head-end may have a “98004 zip code with a 4-mile radius from this zip code” as a localization parameter. Thus, the incoming shopping data from the data feeds 112 can be scanned to identify pieces of data (such as advertisements) that are tagged with identifiers specifying a range of within a 4-mile radius of this 98004 zip code, and then this localized shopping data can be provided to the Bellevue, Wash. head-end.

It is appreciated that other types of localization parameters may be used. For example, geographical localization may be based in part on time zone. Localization may also be based on demographic parameters, such as income bracket, ethnic background, occupation, interests, hobbies, and so forth. Such demographic parameters may be generated by using census or survey data. Thus, as an example, if census data indicates that a certain neighborhood in a city has a predominant population from a certain ethnic group, the channel configuration records 204 corresponding to a head-end in that neighborhood can specify the types of synthetic channel content to present that would be of great interest to the ethnic group. For localization based on income bracket, the channel configuration records 204 can be used to extract data from the data feeds 112 that fall within a certain price range, for instance for a synthetic shopping channel.

A server module 202 uses the configuration records 204 to decide which data to get from the database 200 and where (e.g., head-end 106) to send it. The server module 202 sends certain non-local content (such as national news) specified by the configuration records 204 to all head-ends 104, and uses the localization parameters in the configuration records 204 to identify local content in the database 200 and send that local content to its corresponding head-end. Thus, the configuration records 204 may be thought of instructions given to the server module 202 as to how to filter (localize) the data in the database 200.

In one embodiment based on a technique described in further detail in the Digeo Docket No. 677 co-pending application identified above, the server module 202 (or other server component) uses the information from the configuration records 304 to build and populate fields associated with distribution center objects. Each of the distribution center objects may include, for instance, a routing identifier field, multiple system operator (MSO) field, distribution center field (specifying the location of a head-end), application field (specifying a particular synthetic channel, sub-application fields (specifying additional content to present in the synthetic channel), and so forth. Based on these distribution center objects, the server module 202 then routes to corresponding localized content to the appropriate head-end.

As depicted in FIG. 2A, the local and non-local content can be sent to each distribution center 106 by way of the Internet 102. It is appreciated that other types of communication connection may be used. The corresponding application (such as a shopping application for a synthetic shopping channel) can be pre-installed in each distribution center 106 (such as in the cache 110), rather than being sent from the content source 104. Thus, the applications can be identical for all head-ends in one embodiment—only the content that the applications present, based on localization, will be different from one head-end to another.

In one embodiment, each distribution center 106 includes a carousel server 206 to carousel broadcast the received content and corresponding applications to thin-client terminals 108, without further localization being performed at the distribution center 106. The caches 110 (or other storage unit) in the distribution center 106 can be used to store the content in database tables. In an embodiment, the carousel server 206 can be implemented using the Wink™ Broadcast Server in tandem with its Distributed Server Module Architecture (DSMA) server to insert applications into the cable broadcast stream and to insert update resources into the applications. Carousel transmission of content and corresponding applications via MPEG data pipes is described in further detail with reference to FIG. 2C.

FIG. 2B is a block diagram showing another embodiment to provide content and applications to thin-client terminals 108. In the previously described embodiment depicted in FIG. 2A, little or no localization is performed downstream of the content source 104. In FIG. 2B, localization is performed in intermediate locations between the content source 104 and the final head-ends.

The data from data feeds 112 are loaded into the main database 200 in the content source 104, with such incoming data being “nationwide” in scope. The received data is then organized into the database 200 into smaller groups of information for particular regions A, B, C, D. Such organization operation may use, for instance, tags in the incoming data that identify the data to the A-D regions.

Next, the data is sent from the database 200 to locations 240-246 corresponding to A-D regions. The locations 240-246 can be head-ends, servers, databases, other portals, or combination thereof. At the locations 240-246, the data is further localized into smaller sub-groups, such as sub-groups D-1 to D-4 for region D in Texas for the location 246. This process may be repeated as many times as needed, until highly localized content is pinpointed to the ultimate thin-client terminals 108 that are to receive the content.

In one embodiment, the initial data feeds 112 can include all of identifiers/tags to be used for each subsequent downstream localization. Alternatively or in addition, identifiers can be added to the data at any of the intermediate locations in the data flow, with such identifiers being used by the next downstream component to perform the next level of localization.

FIG. 2C illustrates carousel transmission of content and applications in different data pipes according to an embodiment of the invention. A “data pipe” can comprise an MPEG-2 stream having a unique program identifier (PID) in one embodiment, where all data packets in the same stream have the same PID or the stream can have packets with different PIDs. Carousel transmission may occur constantly and independent of a request from a thin-client terminal 108 (e.g., the data is “pushed” to thin-client terminals 108).

The example of FIG. 2C illustrates carousel transmission of a shopping application for a synthetic shopping channel, and transmission of its corresponding shopping content. According to one embodiment, carousel transmission and rendering by the thin-client terminal 108 can be optimized by arranging the placement of the application and content in the data pipes based on expected viewer behavior.

For instance, a typical viewer wishing to make an online purchase from a shopping channel generally performs the following steps in this order: tune to the shopping channel, choose a shopping category (such as outdoors or household) or choose a store, peruse the available products, and make a purchase. Optimization can be improved, therefore, by placing the store listings on a separate data pipe than the product listings—once the relevant store has been chosen by the viewer, the thin-client terminal 108 can tune to receive and begin rendering the list of available products. However, if the stores were placed in the same data pipe as the list of products, then the thin-client terminal 108 would have to “wait” longer to “pick off” a particular store from the carousel (if it was missed during its first rotation), since the long list of products would have to finish carouseling through before the stores repeat their carousel.

Therefore in FIG. 2C, a first data pipe 208 having a PID 123 carousels an application start portion 210, the shopping channel application 212, an application end portion 214, application data 216, and the repeat of the application start 210 and onward. The application data 216 can include, for instance, content that should be rendered fairly shortly after the application begins executing, such as a banner for the shopping channel that alerts the viewer that he has tuned to the correct channel.

A second data pipe 218 having a PID 124 carousels shopping categories 220 and store listings 222. A third data pipe 224 carousels product listings 226-232. Additional data pipes may be provided for the shopping channel, if needed.

FIG. 2D illustrates an embodiment to map synthetic channels having content and applications into an electronic program guide having conventional television channel listings. The mapping may be used, for example, to identify which MPEG data stream to tune to when the viewer selects a synthetic channel.

EPG data 234 can be received from an out-of-band channel and stored in the thin-client terminal 108. The EPG data can include a list of channels (both conventional broadcast channels and interactive synthetic channels), program descriptions, show times, and the like. A synthetic channel map 236 (such as a Wink™ Service Map) identifies the available synthetic channels that the service provider has configured for the head-end. The information for the synthetic channel map may also be downloaded into the thin-client terminal 108 via an out-of-band channel. An STB channel map 238 lists the channels (both conventional broadcast channels and interactive synthetic channels) available to the thin-client terminal 108, their frequencies, and MPEG information if appropriate (such as the PID 123 of the MPEG stream to which to tune to obtain the shopping channel application).

If the viewer tunes to a synthetic channel by way of an EPG, the EPG data 234 links with the synthetic channel map 236 and/or the STB channel map 238 to locate the appropriate frequency and MPEG stream to tune to. If the viewer tunes to a synthetic channel directly with a remote control and does not use an EPG, then the STB channel map 238 links with the synthetic channel map 236 to locate the appropriate frequency and MPEG stream to tune. Thus, the viewer may tune to synthetic channels having content using similar techniques as those used to tune to conventional television broadcast channels.

FIG. 3 is a block diagram of an embodiment of a client terminal 108 for the system 100 of FIG. 1 that can implement an embodiment of the invention to present content and applications. For the sake of simplicity of illustration and explanation, only the components that are germane to understanding an embodiment of the invention are shown in FIG. 3. It is understood that the embodiment of the client terminal 108 shown in FIG. 3 can have other components different than or in addition to what is shown. Moreover, the various illustrated components may be suitably combined in some embodiments, instead of being separate. It also should be noted that the client terminal 108 is only one embodiment of the invention and that some or all of the components described as embodied in the client terminal 108 can be incorporated into a client television rather than in a separate device. A bus 301 is shown symbolically to depict coupling between the various components.

The client terminal 108 comprises a first tuner 300 to tune to a Moving Pictures Experts Group (MPEG) stream 302 or other video source. The stream 302 may include video, live transmission, and/or application code, including corresponding text and graphic resources (including content) that are carousel transmitted. One skilled in the art will recognize that there will be a plurality of streams 302, depending on the number of channels and programs that the cable service provider makes available to the client terminal 108. Such stream(s) 302 can include MPEG-2 streams, each associated with a unique program identifier (PID). Different PIDs also may be in the same frequency band as the stream 302.

The first tuner 300 is coupled to a decoder 306 (such as an MPEG decoder) that decodes the video, application, and/or audio into a format that is compatible with a television set coupled to the client terminal 108. Some embodiments of the client terminal 108 may include a second tuner 310. The second tuner 310 can work in conjunction with a cable modem 312 to obtain perhaps some local content 314 from the Internet 102, such as via a Data Over Cable Service Interface Specifications (DOCSIS) connection with the distribution center 106. In one embodiment, the second tuner 310 can be used to obtain interactive data from a server (such as that used by a merchant or advertiser or content provider), remote database, Internet location or web site, or other source depicted in FIG. 1.

In addition, the client terminal 108 includes or is coupled to an input interface 315, through which other sources 316 of data can be provided to the client terminal 108. An example of the input interface 315 comprises an out-of-band tuner that can be used to receive electronic program guide (EPG) information and EPG applications, an application engine (such as a Wink™ engine for management of content and applications from a carousel transmission), and so forth, from an out-of-band channel. In an embodiment, the out-of-band channel(s) can comprise one or more low-bandwidth frequencies carried on the same coaxial cable used to provide the MPEG streams and Internet content.

Yet another example of the input interface 315 is an interface to receive outputs of recording devices such as a personal video recorder (PVR) or a digital video recorder (DVR). Alternatively or in addition, the input interface 315 can comprise a communication interface, such as an Ethernet connection, a digital subscriber line modem, a wireless communication interface, and so forth, which can provide a link to the distribution center 106 or other source.

An embodiment of the client terminal 108 may include a processor 320 to control operation of the various components shown in FIG. 3. The processor 320 may work in conjunction with an operating system (O/S) 324 or other software or machine-readable instructions stored on at least one machine-readable storage medium 322. An audio and video output subsection 308 of the client terminal 108 receives decoded video, content, and applications, and provides the decoded information to a television set. In one embodiment, the output subsection 308 can also be coupled to a peripheral device, such as a separate DVR or PVR. A wireless interface 318 operates to receive commands from a user input device (such as a wireless remote control). Such commands can include user commands to tune to a particular channel having content. The wireless interface 318 provides these commands to the processor 320 so that the processor 320 can cooperate with the appropriate hardware and software to perform the corresponding operation.

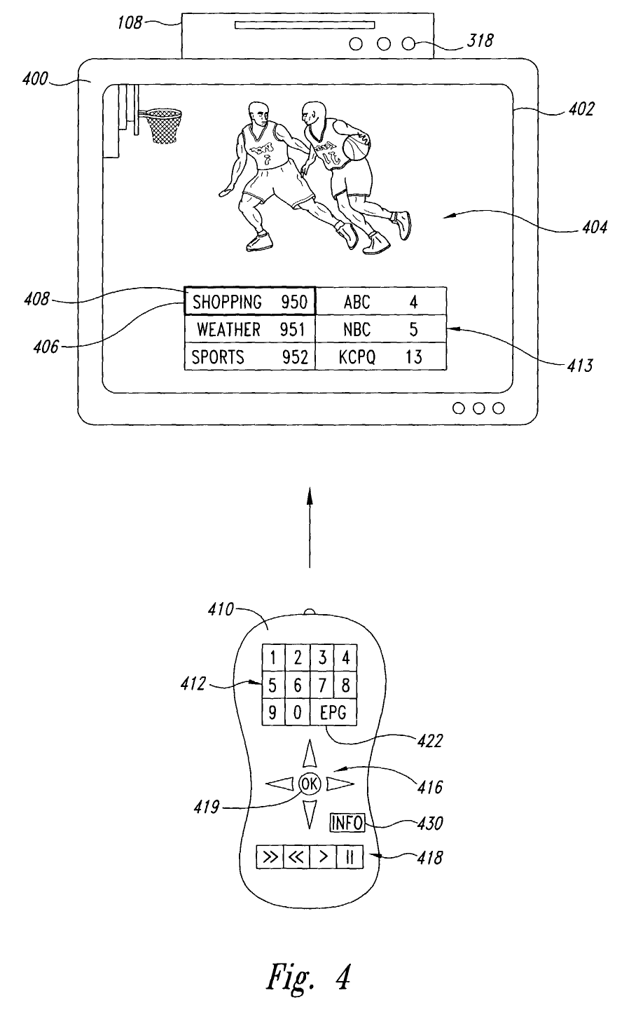

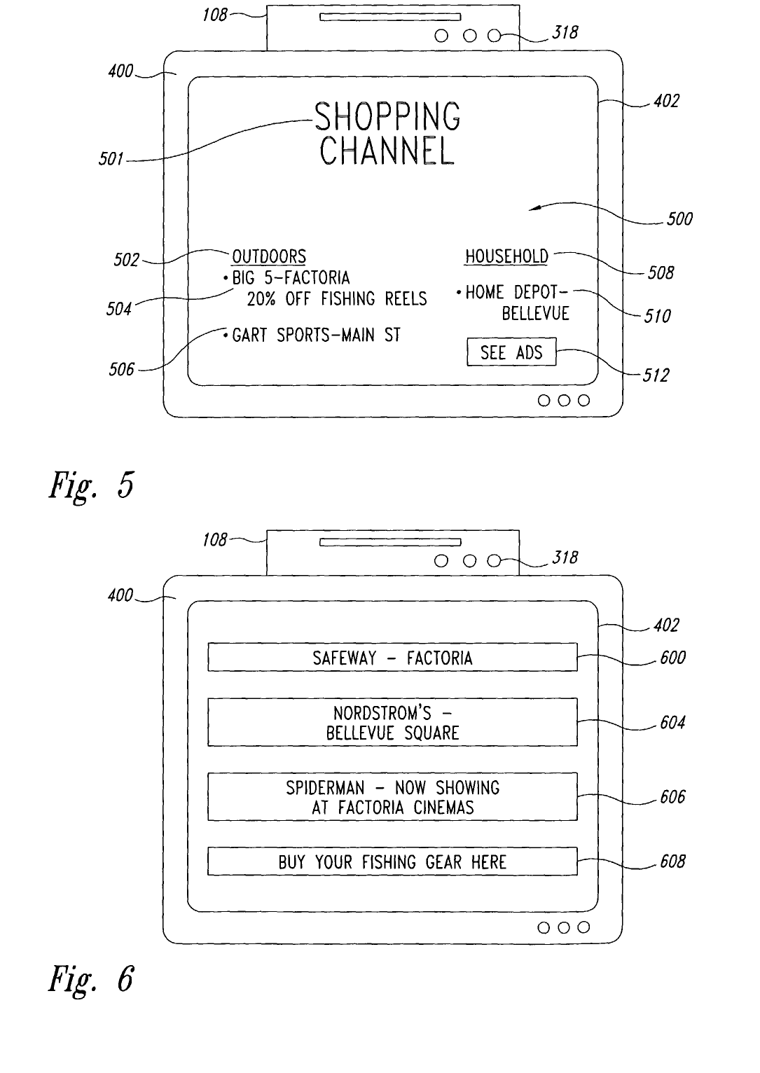

FIG. 4 is an example screen shot in conjunction with a remote control 410 for implementing one embodiment of the invention to present content. For simplicity of explanation, not all of the possible types of content are shown or described in the various screen shots, as such other possible information can be ascertained by examination of the examples specifically shown in the figures. Moreover, it is to be appreciated that the format, layout, direction, content, and other characteristics of the content selections shown in FIGS. 4-6 are merely illustrative and that variations are possible. For purposes of illustration and explanation, content for shopping is depicted in FIGS. 5-6. It is of course to appreciated that other types of content can be provided, including but not limited to weather, sports, entertainment, finance, news, and so forth.

In FIG. 4, a television set 400 is coupled to the client terminal 108 in a manner that allows a display screen 402 of the television set to show a television program 404. The television program 404 in this example is a basketball game, and it is appreciated that other types of television programs can be shown, such as commercials, public service announcements, and so forth.

A wireless remote control 410 is in communication with the client terminal 108 (via the wireless interface 318) to perform conventional television-viewing operations and also to request and interact with content, as will be described below. The remote control 410 includes an alphanumeric keypad 412 that the viewer can use to select television channels or interactive content channels that have content. Buttons 418 can comprise buttons that are similar to play, rewind, fast forward, pause, etc. buttons usable for recording devices. Arrow keys 416 may be used for tuning from one channel to another or to “tab” from one element to another presented in an EPG 413 rendered on the display screen 402. An OK button 419 may be used to confirm viewer selections.

In an embodiment, the remote control 410 can include an EPG button 422, which if pressed, causes a command to be sent to the client terminal 108 to instruct its software to render the EPG 413 on the display screen 402. If the EPG button 422 is pressed again, the EPG 413 is taken off the display screen 402. Alternatively or in addition, other buttons can be pressed to dismiss the EPG 413.

In the illustrated example of the EPG 413, various grids display channel and program selections for the viewer. These include, for instance, standard nationally broadcasted channels such as ABC (on Channel 4) and NBC (on Channel 5). The EPG 413 also includes regional channels such as KCPQ (on Channel 13). According to an embodiment, the EPG 413 can be configured to present one or more interactive “synthetic” channels that provide content, including local content. In the illustrated example, there is a synthetic Sports Channel 952 for local or national sports, and a synthetic Weather Channel 951 for local or national weather.

There is also a synthetic Shopping Channel 950, through which the viewer can interact to view advertised products from merchants, and to perform interactive purchases or informational transactions. The viewer may tune to the Shopping Channel 950 by navigating to its grid 408 via a selection rectangle 406. The selection rectangle 406 may be moved from one grid to another of the EPG 413 via use of the arrow keys 416 on the remote control 410, and then pressing the OK button 419 instructs the first tuner 300 of the client terminal 318 to tune to the channel in the grid surrounded by the selection rectangle 406. Alternatively, the viewer may tune to a particular channel without using the EPG 413, such as by explicitly entering the channel number via the keypad 412 or by pressing the up/down arrow buttons 416 to tune from one channel to another.

FIG. 5 shows an example of the synthetic Shopping Channel 950 that presents product and merchant content to the viewer. The channel is presented via a screen template 500, which is rendered after the corresponding shopping channel application is downloaded and executed. As depicted in the example, the template 500 has fields that have been populated with various text and graphics. These include a shopping channel banner 501; product categories 502 (outdoors) and 508 (household); interactive advertisements 504, 506, and 510 under each category; and a link 512 to view additional advertisements within the Shopping Channel.

As previously described above with reference to FIG. 2C, one embodiment of the invention optimizes the transmission and subsequent rendering of the interactive content by arranging the applications and content in data pipes based on predicted viewer behavior. For FIG. 5, for instance, a first data pipe may carousel the shopping channel application (and template), along with a piece of content that should be rendered quickly and first (such as the channel banner 501 to indicate to the viewer that he has tuned to the correct channel). The next data pipe to tune to, according to the code in the shopping channel application, can be a second data pipe that carries the categories 502 and 508 (since many viewers are likely to scan for product categories before they scan for specific advertisements). The next data pipe(s) to tune to can be ones that carry the various advertisements 504, 506, and 510. Perhaps a last data pipe to tune to can carry the link 512, since it is a “miscellaneous” link that a viewer may access if he does not find what he needs from the previously displayed content.

The localization shown in FIG. 5 can be based on one or more localization parameters. In terms of a geographic localization (for a viewer living in Bellevue, Wash.), the Big 5, Gart Sports, and Home Depot advertisements (504, 506, and 510 respectively) and advertisements available via the link 512 can be from merchants located within a radius roughly referenced/centered to the zip code of the viewer.

The localization may alternatively or additionally be based on demographic data. For example, demographic data (such as from a census or survey) may indicate that viewers served by a certain head-end are in a particular income bracket, favor outdoor sports, or live in new-home-construction neighborhoods. Thus, the advertisements 504 and 506 may be localized based on the outdoor sports interest (such as fishing) or on the particular income bracket (e.g., 25% off on fishing reels that typically range in price from $15 to $40, which is affordable to most middle-income individuals, for instance). The Home Depot advertisement 510 may be localized based on the new-home-construction demographic, where residents of such homes often shop for “do-it-yourself” household products. The Home Depot advertisement 510 may also be localized based on income demographics, where for instance, many people in the middle-income bracket tend to try to save money by doing household projects themselves, rather than paying large sums of money to contractors to install expensive custom-built household components.

FIG. 6 illustrates another area of the Shopping Channel 950 or from some other interactive area, if the viewer clicks on the advertisement link 512 in FIG. 5. The interactive area of FIG. 6 shows a “walled garden” implementation, where the viewer is only allowed to access interactive areas specifically designated by the interactive service provider. In the example shown, the interactive area presents advertisements for products (e.g., an advertisement 608 for fishing gear), merchants (e.g., an advertisement 600 for a branch of a grocery store, and an advertisement 604 for a branch of a retail store), and entertainment (e.g., an advertisement 606 for a movie theater, which may be linked to a synthetic Entertainment Channel). The walled garden delineated for this viewer, therefore, includes interactive areas (including participating merchant sites) localized to the viewer—the viewer's is not presented with advertisements or merchant sites from geographically distant (or otherwise non-localized) areas that are not relevant to the viewer.

It is appreciated that in one embodiment, the viewer can be allowed to access areas outside of the walled garden. For instance, special passwords, permissions, or subscriptions can be provided, if requested by the viewer through his service provider, to access “premium” interactive services, non-localized content, and other content.

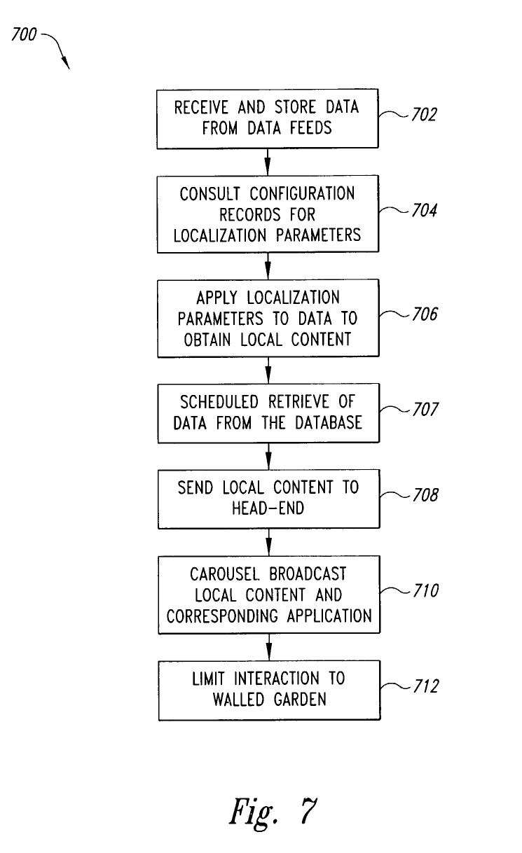

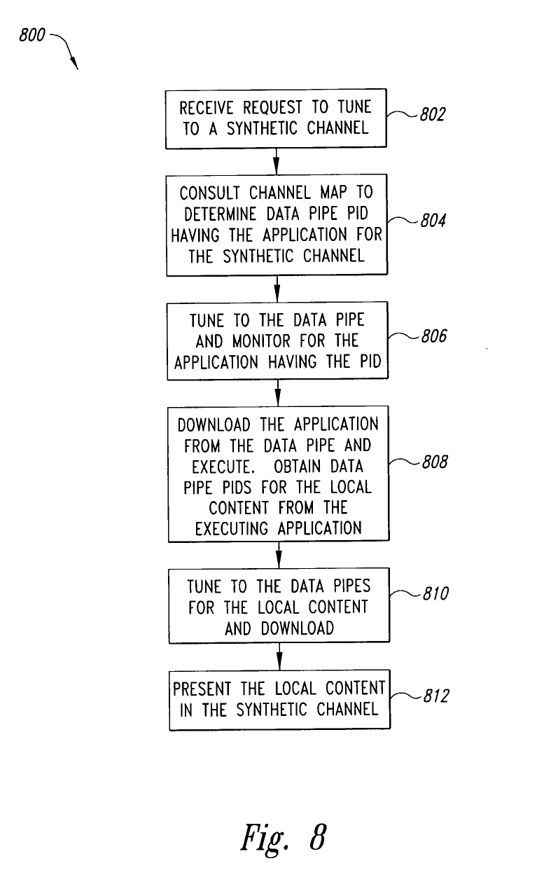

FIG. 7 is a flowchart 700 depicting operations associated with providing content for carousel transmission to a thin-client terminal according to one embodiment of the invention. The various operations depicted in FIG. 7 may be performed at a head-end, at a portal, or a suitable intermediate location depicted in FIGS. 1 and 2A-2B that is remote from the client terminals 108. Elements of the flowchart 700 (as well as the flowchart 800 of FIG. 8) may be embodied in software or other machine-readable instruction stored on a machine-readable medium, such as the storage medium 322 or storage location at a head-end. Moreover, operations shown in the flowcharts 700 and 800 need not necessarily occur in the exact order shown.

Beginning at a block 702, data from the data feeds 112 is received and stored in the database 200. At a block 704, the server module 202 consults the channel configuration records 204 to determine which data in the database 200 to obtain and where to send it.

At a block 706, the server module 202 applies the localization parameters in the channel configuration records 204 to obtain the local content from the data stored in the database 200. At a block 707, there may be scheduled retrieves of the localized data or other data from the database 200 for distribution to the head-ends 106. Next at a block 708, the server module sends the local content to head-ends 106.

At the head-ends 106, the carousel server 206 carousel broadcasts content and its corresponding application on a plurality of data pipes, such as depicted in FIG. 2C. A walled garden effect is achieved at a block 712 that limits the interactive areas that the viewer can access, by sending the viewer only content and applications specific to the head-end or client terminal 108.

The flowchart 800 of FIG. 8 illustrates thin-client terminal operations associated with obtaining and presenting content according to an embodiment of the invention, which may be performed by the client terminal 108. The operations depicted in FIG. 8 can work in conjunction with at least some of the operations depicted in FIG. 7.

Beginning at a block 802, the thin-client terminal 108 (by way of the wireless interface 318) receives a request to tune to a synthetic channel, such as from the remote control 410. The command may be issued by pressing a channel button on the remote control 410, or via selection from a grid on the EPG 413.

Next at a block 804, software of the thin-client terminal 108 consults one or more channel maps (such as shown in FIG. 2D) to determine the data pipe PID for the application corresponding to the requested synthetic channel. Once that data pipe and PID are determined, the tuner 300 (or other tuner) tunes to that data pipe and monitors for the relevant application in the carousel broadcast.

Once detected, the application is “picked off” or otherwise downloaded from the data pipe at a block 808, and executed. During the course of execution, the downloaded application will specify the data pipes, PIDs, and order of download for the content to be populated into the application template.

The tuner 300 tunes to the specified data pipes at a block 810, looks for the content having the specified PIDs, and downloads them from the carousel broadcast. The downloaded content is then presented in the application template on the synthetic channel at a block 812.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention and can be made without deviating from the spirit and scope of the invention.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

What is claimed is:

1. A method for facilitating delivery of data in a carousel broadcast, the method comprising:
identifying an expected viewer behavior when using an application;
assigning categories of data associated with the application to separate carousels based on the expected viewer behavior; and
broadcasting data from the categories via their assigned carousels.

2. The method of claim 1 wherein identifying the expected viewer behavior includes:
determining an expected sequence of actions a viewer will perform when using the application; and
further determining which categories of data are likely to be accessed before other categories of data based on the expected sequence of actions.

3. The method of claim 2 wherein assigning categories of data associated with the application to separate carousels based on the expected viewer behavior includes assigning those categories of data likely to be accessed before other categories of data to the separate carousels to expedite their arrival.

4. The method of claim 1 wherein the carousels comprise data pipes uniquely identified via a program identifier (PID).

5. The method of claim 1, further comprising broadcasting the application in a carousel.

6. The method of claim 1, further comprising at a client terminal receiving the broadcasted data:
obtaining the application from a carousel and executing the obtained application;
identifying carousels to which certain categories of data were assigned and obtaining the data therefrom in an order specified in the application; and
rendering the obtained data.

7. A method, comprising:
assigning an application to a carousel-broadcast data pipe;
assigning content associated with the application to a plurality of different carousel-broadcast data pipes based on an expected user behavior;
placing the application and its associated content in their respective data pipes; and
carousel broadcasting the application and its associated content in their respective data pipes.

8. The method of claim 7 wherein placing the application and its associated content in their respective data pipes includes:
placing the application and a first type of the content on a first data pipe;
placing a second type of the content on a second data pipe; and
placing at least a third type of the content on at least a third data pipe.

9. The method of claim 8 wherein the first type of content includes content categories, the second type of content includes subcategories under the categories, and the third type of content includes items under the subcategories.

10. The method of claim 8 wherein the application specifies the data pipes from which to obtain at least some of the types of content.

11. A system for facilitating delivery of data in a carousel broadcast, the system comprising:
a means for identifying an expected viewer behavior when using an application;
a means for assigning categories of data associated with the application to separate carousels based on the expected viewer behavior; and
a means for broadcasting data from the categories via their assigned carousels.

12. The system of claim 11, further comprising:
a means for obtaining the application from a carousel and executing the obtained application;
a means for identifying carousels assigned to certain ones of the data based on the executing application and obtaining the data therefrom in an order specified in the application; and
a means for presenting the obtained content.

13. A system, comprising:
an application storage unit to store an application corresponding to content; and
a carousel server coupled to the application storage unit and coupled to receive the content, the carousel server being configured to carousel broadcast the application on at least one data pipe and the content on a plurality of different data pipes in a manner that is based on an expected user behavior when the application is in use.

14. The system of claim 13 wherein the expected user behavior includes an expected sequence of actions to be performed when the application is in use and wherein configuration of the carousel server to carousel broadcast the content includes configuration based on which content is likely to be accessed before other content based on the expected sequence of actions.

15. The system of claim 13 wherein the data pipes comprise data pipes uniquely identified via a program identifier (PID).

16. The system of claim 13 wherein the carousel server is configured to place the application and a first type of the content on a first data pipe, place a second type of the content on a second data pipe, and to place at least a third type of the content on at least a third data pipe.

17. The system of claim 16 wherein the first type of content includes content categories, the second type of content includes subcategories under the categories, and the third type of content includes items under the subcategories.

18. The system of claim 13 wherein the application specifies the data pipes from which to obtain at least some of the content.

19. The system of claim 13, further comprising a client terminal to receive the carousel broadcasted application and content, the client terminal including:
at least a first tuner to tune to the data pipes having the content and its corresponding application;
an interface to receive a command from a user input device to tune to a channel associated with the carousel broadcasted content and application; and
a processor, coupled to the tuner and to the interface, to cooperate with a software program stored in a storage medium to, in response to the received command, monitor the data pipes for the content and the application and to obtain the content and the application therefrom and to present the content and application on the channel.

20. A system, comprising:
an application storage unit to store an application corresponding to content;
a carousel server coupled to the application storage unit and coupled to receive the content; the carousel server being configured to carousel broadcast the application on at least one data pipe and the content on a plurality of different data pipes in a manner that is based on an expected user behavior when the application is in use,
wherein a client terminal for a television is coupled to receive the carousel broadcast of the application and content, and
wherein the television includes a screen to present the received application and content;
a plurality of content sources communicatively coupled to a broadcast center having the application storage unit and the carousel server; and
a portal coupled between the content sources and the broadcast center to provide the content to the carousel server.

21. The system of claim 20 wherein the application specifies the data pipes from which to obtain at least some of the content.

22. The system of claim 21 wherein the application further specifies a command to tune to the data pipes to obtain the content and a command to present the obtained content and application in a channel.
